(19) United States
(12) Patent Application Publication
(10) Pub. No.: US 2006/0103759 A1
(43) Pub. Date: May 18, 2006

(54) Disk video camera

(75) Inventors: Toshimasa Kamisada, Hiratsuka (JP); Yasuo Kitada, Odawara (JP); Yoshiro Konishi, Mito (JP); Ryuichiro Mizuno, Fujisawa (JP); Chieko Fukui, Yokohama (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 11/116,653

(22) Filed: Apr. 27, 2005

(30) Foreign Application Priority Data
Nov. 12, 2004 (JP) 2004-328363

(51) Int. Cl. H04N 5/225

(52) U.S. Cl. 348/374

(57) ABSTRACT

In order to provide an optical disk video camera capable of being reduced in dimensions inclusive of thickness, part of an optical head 10 disposed such that on a projection plane parallel to the surface of an optical disk 5, a seek motor 12 is disposed at a side opposite to a camera lens 2, with respect to the optical head 10, and such that a laser diode 18 and a holder 27 are arranged at sides opposite to the camera lens 2, with respect to an objective lens 24, is caused to overlap on the camera lens 2, on a projection plane parallel to a central axis of the camera lens 2 and perpendicular to the optical disk 5.

### CLAIM OF PRIORITY

The present application claims priority from Japanese application serial no. JP 2004-328363, filed on Nov. 12, 2004, the content of which is hereby incorporated by reference into this application.

### BACKGROUND OF THE INVENTION

1. Field of the Invention

The present invention relates to video cameras, and more particularly, to the disk video cameras that each use a disk as a recording medium.

2. Description of the Prior Art

Background technology concerned with the present invention relating to disk devices is proposed in Japanese Patent Laid-Open No. 8-339546. Japanese Patent Laid-Open No. 8-339546 gives the following description: “an object of the invention is to provide a compact optical disk drive and electronic device” (according to “Object” of the “Abstract” in Japanese Patent Laid-Open No. 8-339546), and “in addition to having a lens holder 218 movably provided in a lens unit 212, the invention has both the lens holder 218 and the lens unit 212 connected via suspensions 229, 230, 231, 232, and has an optical pickup package 242 installed at the roots of the lens unit 212 where the suspensions 229, 230, 231, 232 are provided” (according to “Construction” of the “Abstract”, and FIGS. 1, 2, 8, in Japanese Patent Laid-Open No. 8-339546).

### SUMMARY OF THE INVENTION

However, the above Japanese Patent Laid-Open No. 8-339546 only describes the optical disk drive itself and does not describe a video camera that uses the optical disk drive as a recording device. An object of the present invention is to provide a video camera that uses an optical disk drive as a recording device, the optical disk drive having its entirety miniaturized.

The above object is achieved by the invention set forth in “Claims” of the present Specification.

A compact video camera can be realized, according to the present invention.

### BRIEF DESCRIPTION OF THE DRAWINGS

FIG. 1 is a side view of an optical disk video camera which is a first embodiment of the present invention;

FIG. 2 is a front view of the optical disk video camera in the first embodiment of the present invention;

FIG. 3 is a plan view of the optical disk video camera in the first embodiment of the present invention;

FIG. 4 is a side view of the optical head used in the first embodiment of the present invention;

FIG. 5 is a cross-sectional view of the optical head used in the first embodiment of the present invention;

FIG. 6 is a side view of an optical disk video camera which is a second embodiment of the present invention;

FIG. 7 is a front view of the optical disk video camera in the second embodiment of the present invention; and

FIG. 8 is a plan view of the optical disk video camera in the second embodiment of the present invention.

### DESCRIPTION OF THE PREFERRED EMBODIMENTS

Embodiments of the present invention will be described hereunder using the accompanying drawings.

### First Embodiment

In the following description of the drawings, for convenience's sake in the description, the terms “X-direction”, “Y-direction”, and “Z-direction” are used as necessary. The meanings of these directions are the same throughout this Specification. In addition, where necessary, an X-arrow direction is expressed as rearward; an opposite direction thereof, as forward; a Z-arrow direction, as upward; an opposite direction thereof, as downward; and a Y-axis direction, as transversely.

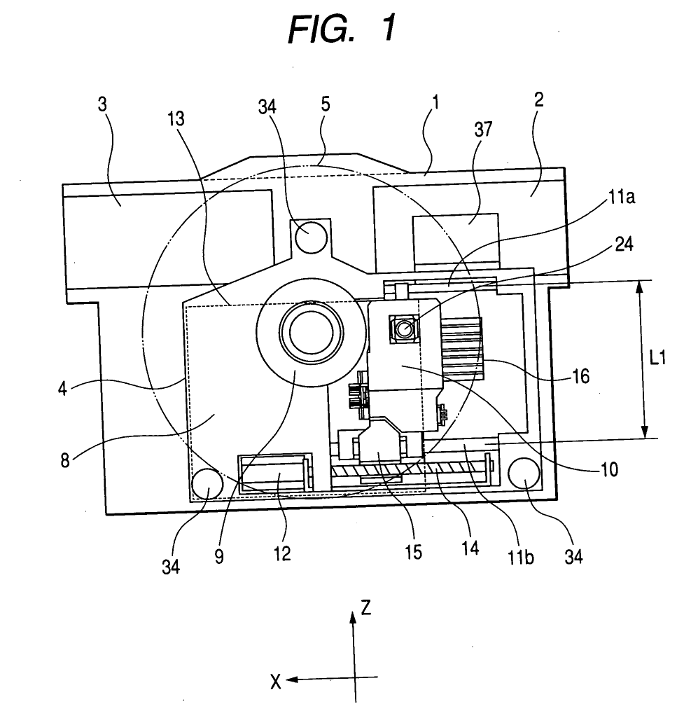

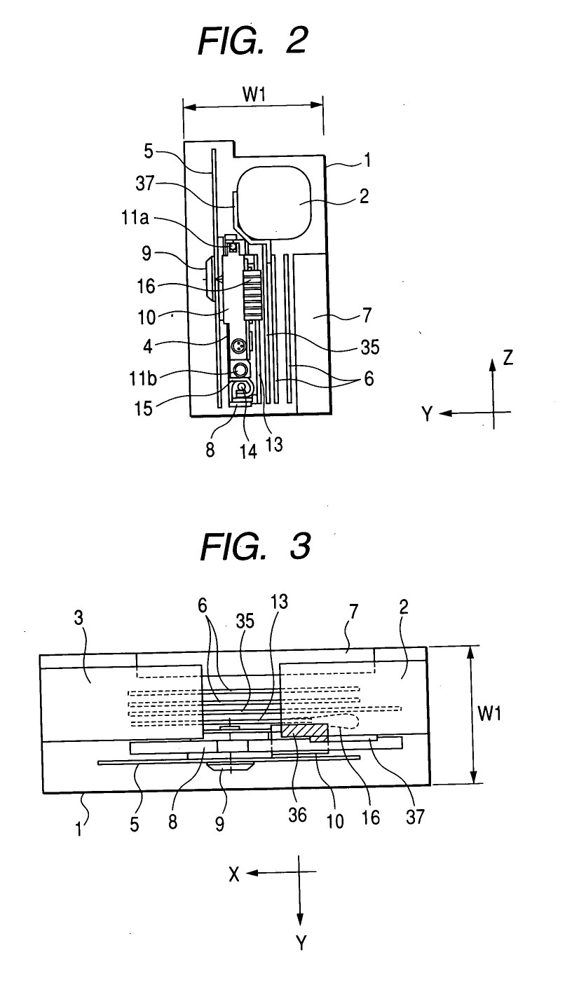

FIG. 1 Is a side view showing an optical disk video camera In a first embodiment of the present Invention when the video camera Is In a photographing state. FIG. 2 Is a front view of the video camera when It Is viewed from a direction opposite to the X-direction. FIG. 3 is a plan view of the video camera when viewed from the Z-direction.

A camera enclosure 1 In FIGS. 1, 2, and 3 contains components of the optical disk video camera. A camera lens 2 acquires image information of an object to be photographed by a user. A viewfinder 3 and a liquid-crystal monitor 7 display the image information of the object so that the user can confirm the image information. An optical disk drive 4 records on an optical disk 5 the image information that has been acquired by the camera lens 2. A circuit for converting the Image information into signals recordable by the optical disk drive 4 Is mounted on camera circuit boards 6. A chassis 8 contains the components constituting the optical disk drive 4, and Is fixed to a frame 35 via rubber dampers 34. A spindle motor 9 rotates the optical disk 5. An optical head 10 irradiates the optical disk 5 with laser light In order to record the image information thereon. The optical head 10, by receiving the motive power of a seek motor 12 that is transmitted via a lead screw 14 and a rack 15, is driven in the direction guided by guide bars 11. A circuit for controlling the optical disk drive 4 is mounted on a circuit board 13. A flexible cable 16 connects the optical head 10 and the circuit board 13.

Inside the camera enclosure 1, the camera lens 2 and the viewfinder 3 are arranged next to each other in an X-axis direction. Also, the camera lens 2 and the viewfinder 3 are both arranged next to the optical disk drive 4 located transversely (i.e., in a Y-axis direction). For ease of operations in photographing, the camera lens 2 and the viewfinder 3 are typically arranged substantially coaxially in the X-direction at upper sections of the camera enclosure 1 in the Z-direction. The camera circuit boards 6 and the liquid-crystal monitor 7, therefore, are arranged under the camera lens 2 and the viewfinder 3. The frame 35 is fixed to the inside of the camera enclosure 1, and the camera lens 2, the camera circuit boards 6, and the optical disk drive 4 are each arranged around the frame 35 in such a form as to be fixed thereto. Furthermore, in order to reduce the vibration and shocks transmitted from the camera enclosure 1 to the optical disk drive 4, the drive 4 is fixed to the frame 35 via the rubber dampers 34. The viewfinder 3 is fixed directly to the camera enclosure 1. The camera lens 2 is a zoom lens. Therefore, since significant size reduction of the camera lens 2 must be limited to ensure desired exposure, this lens occupies a space measuring about 30 mm in diameter and a dimension greater than this diameter, in terms of length. The viewfinder 3 also has substantially the same size as that of the camera lens 2. It goes without saying, however, that with technical progress and depending on particular needs, the camera lens 2 and viewfinder 3 used can be smaller than the above size.

The optical disk drive 4 records image information of a photographed object, on the optical disk 5. More specifically, the image information is recorded by irradiating laser light from the optical head 10 electrically connected to the circuit board 13 by the flexible cable 16, onto the optical disk 5 installed at and rotated by the spindle motor 9.

The optical head 10 in the present embodiment is downsized so that a clearance L1 between two guide bars, 11a and 11b, can be narrowed to about 40 mm.

It is necessary for an objective lens 24 to be moved between inner and outer edges of the optical disk 5 in a radial direction thereof. As shown in FIG. 1, when the optical head 10 moves to the inner or outer edge of the optical disk 5, it is preferable that a moving direction of the optical head 10 should be parallel to the X-direction to minimize height (Z-directional dimension) of the optical disk video camera. A vertical (Z-directional) position of the objective lens 24 is therefore set on a line parallel to the X-axis passing through a central portion of the spindle motor 9. It is also desirable that the optical head be moved in a parallel direction with respect to the X-axis parallel to a central axis of the camera lens 2, and the guide bars 11a, 11b guide the optical head to make it move in that way.

Narrowing the L1 clearance between the two guide bars, 11a and 11b, makes it unnecessary for height from the center of the optical disk to the bottom of the camera enclosure 1 to be changed, even if the seek motor 12 is disposed below the optical head 10. Since a clearance from the objective lens 24 to upper guide bar 11a can also be reduced by narrowing the L1 clearance, a large portion of the chassis 8 can be downsized to substantially the same height as that of an outer-surface central portion of the spindle motor 9.

Reducing the L1 clearance in this way makes it possible to dispose a portion of the camera lens 2 in an overlapped form on the optical head 10 and the chassis 8 without enlarging the Z-directional dimension of the camera enclosure 1, and thus to bring the camera lens 2 much closer to the optical disk 5. Although it is necessary to provide a wall between the optical disk 5 and the camera lens 2 to keep hands away from the camera lens 2 during mounting/dismounting of the optical disk 5, a clearance from the camera lens to the disk can be reduced to a maximum of about 4 mm in the present embodiment. For conventional video cameras, the minimum achievable clearance from an optical disk 5 to a camera lens 2 has been about 15 mm.

In the present invention, the camera enclosure 1 can be thinned down to a thickness (W1) of about 50 mm by disposing the camera lens 2 at the above position. More specifically, the thinning-down is possible by reducing the L1 clearance and disposing the camera lens 2 so that when the seek motor 12, the camera lens 2, and the spindle motor 9 are projected onto a surface parallel to that of the optical disk 5, the projection of the seek motor is disposed at a side opposite to the projection of the camera lens, with respect to the projection of the spindle motor. In addition, as shown in FIG. 2, the camera lens 2 and the guide bar 11a can be arranged so that respective projections onto a surface parallel to the optical disk surface do not overlap. If the L1 clearance is great as in conventional video cameras, since the camera lens 2, the guide bars 11a, 11b and the lead screw 14 overlap in the Y-direction, the dimension of W1 increases to about 60 mm. Arranging each element as in the present embodiment, therefore, makes it possible to miniaturize and thin down the entire device.

In FIG. 2, the thickness of the camera enclosure 1 in the Y-direction where the camera lens 2 is disposed can be reduced since the guide bar 11a and the lead screw 14 are arranged so as not to overlap in the Y-direction on the camera lens 2.

The sections of the optical head 10 and chassis 8 that overlap in a Z-axis direction on the camera lens 2 are shown as a shaded section 36. The overlapping area in this case, however, differs according to a size and shape of the camera lens 2 used. Since the optical head 10 moves in the X-axis direction, the overlapping area also changes according to a particular position of the optical head. The X-axis is the axis parallel to the central axis of the camera lens 2. Furthermore, FIG. 3 Indicates an arrangement in which, when the camera lens 2 and the optical head are projected onto a surface perpendicular to the optical disk surface and parallel to the central axis of the camera lens 2, the projection of the camera lens and the projection of the optical head will overlap.

The overlapping area further changes according to the Z-directional and/or X-directional disposition of the camera lens 2, requested from design aspects of the camera enclosure 1. Although increasing the overlapping area reduces thickness W1, the Z-directional position of the camera lens 2 becomes substantially the same as that of the conventional example. Although reducing the overlapping area makes thickness W1 greater than in the above case, the Z-directional position of the camera lens 2 can be made lower than in the conventional example. In the present embodiment, thickness W1 of the camera enclosure 1 is limited by a section at which the optical disk drive 4, the camera circuit boards 6, and the liquid-crystal monitor 7 overlap on one another. Therefore, lowering the Z-directional position of the camera lens 2 by reducing the overlapping area of the camera lens 2 according to a particular thickness of the above-mentioned overlapping section makes it possible to reduce the thickness of the camera enclosure 1 and to obtain the effect that reduces the height thereof at the camera lens 2.

Also, even if the overlapping area is increased, camera lens height can be reduced to such an extent that its maximum value is 10 mm smaller than a diameter (in the present embodiment, 80 mm) of the optical disk 5.

Although the chassis 8 and the camera lens 2 may not overlap on each other, a thickness reduction effect can be obtained by arranging at least a portion of the optical head 10 and that of the camera lens 2 in an overlapped form. In the present embodiment, the camera lens 2, an adapter 37, and the optical head 10 overlap at a portion and this arrangement can yield a thickness reduction effect.

Similarly to the camera lens 2, the viewfinder 3 can also be brought closer to the optical disk 5. This is possible because the seek motor 12 is disposed at a side opposite to the camera lens 2, with respect to the optical head 10, and because part of the viewfinder 3 can be disposed in an overlapped form on an upper portion of the optical disk drive 4 by downsizing the circuit board 13 and the chassis 8.

The circuit board 13 can be downsized by improving its component-mounting density and/or adopting smaller-size components.

### Second Embodiment

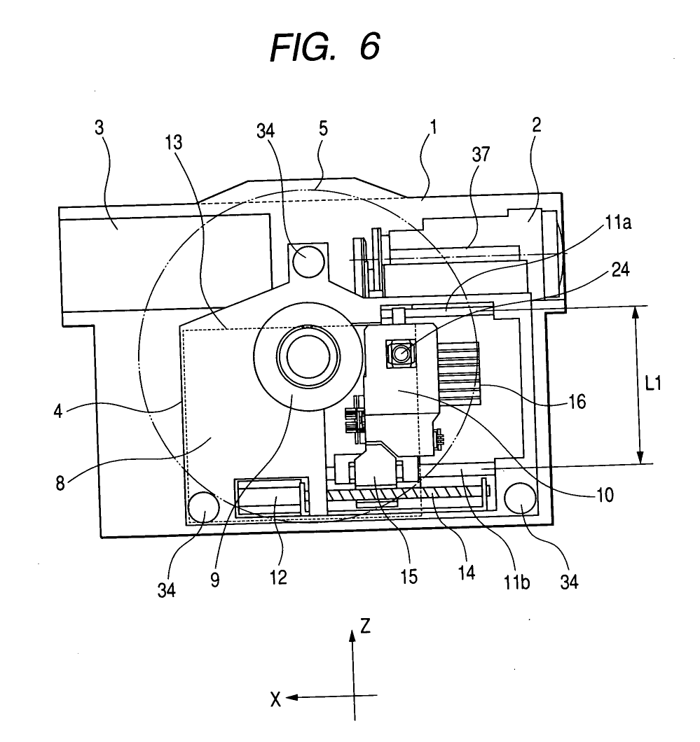

The total video camera device construction, inclusive of a camera lens 2, that differs from the construction shown in FIGS., 1 to 3, is described as a second embodiment below using FIGS. 6 to 8. In the present embodiment, unlike the first embodiment described using FIGS. 1 to 3, part (motor 42) of the camera lens 2 and part of an optical head 10 are arranged so as to overlap on a projection plane parallel to the surface of the optical head. Therefore, an entire video camera according to the present (second) embodiment can be further reduced in dimensions by changing a relative disposing position particularly of a motor 42 of the camera lens 2 with respect to a position of a disk drive. The same reference number is assigned to the constituent elements having the same functions as those of the constituent elements of the optical disk video camera described per FIGS. 1 to 3, and description of these elements is omitted.

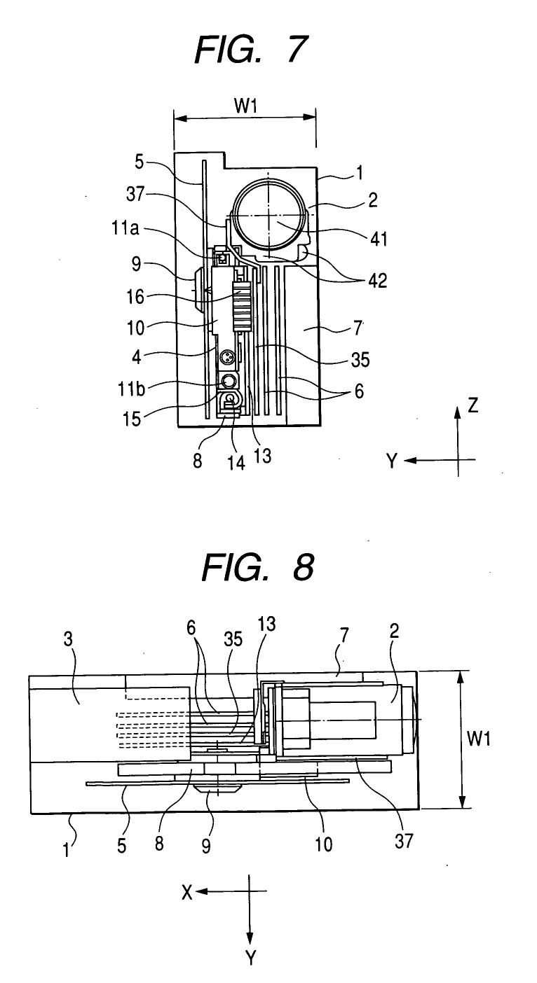

FIG. 6 is a side view of the video camera in a photographing state in the present embodiment. FIG. 7 is a front view of the video camera when it is viewed from a direction opposite to an X-direction. FIG. 8 is a plan view of the video camera when viewed from a Z-direction.

The camera lens 2 includes a plurality of lenses 41, around which are arranged a motor 42 for moving a portion of each lens 41, and another motor 42 for adjusting an iris of the camera lens 2. Automatic focusing and zooming are accomplished by moving the appropriate lens 41 according to a particular functional requirement by means of the appropriate motor 42. As shown in FIG. 7, arranging such motors 42 at sides opposite to Z-directional and Y-directional arrows, respectively, of the camera lens 2, allows the motors to be overlapped on the optical head 10 without moving the camera lens 2 upward in the Z-direction. Such arrangement is therefore effective for further reducing a camera enclosure 1 in dimensions inclusive of thickness.

Thickness WI of the camera enclosure 1 in the present embodiment is also limited by a section at which an optical disk drive 4, camera circuit boards 6, and a liquid-crystal monitor 7 overlap on one another. Thickness can therefore be reduced by, as in the present embodiment, increasing an overlapping area between the optical head 10 and the motors 42 according to a particular thickness of the above-mentioned overlapping section and lowering the Z-directional position of the camera lens 2. Conducting these improvements is also effective for reducing height of the camera enclosure 1 at the camera lens 2.

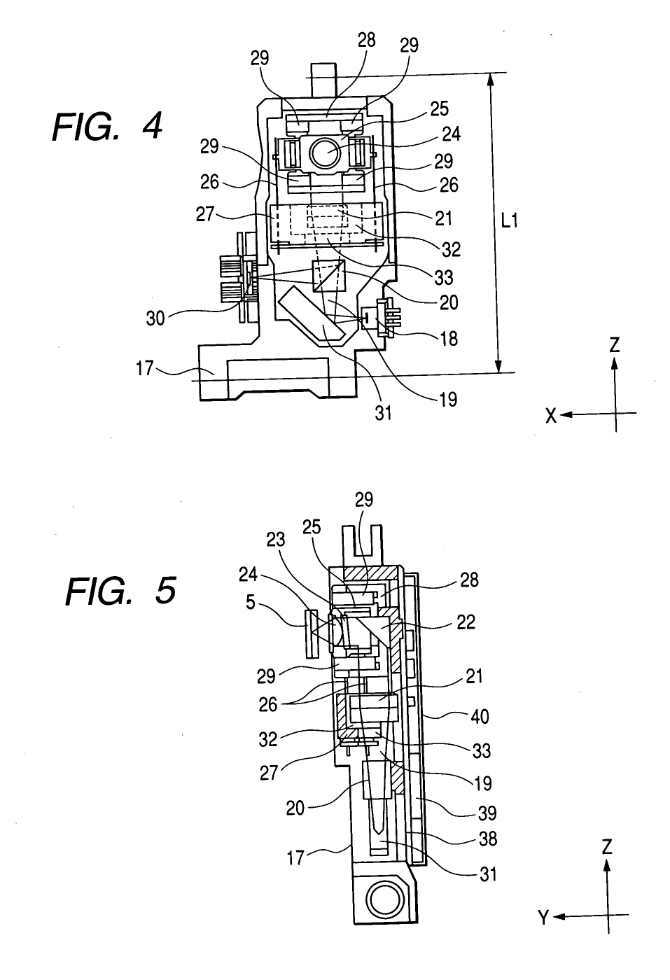

A construction of the optical head 10 used in the optical disk video camera of the above (first) embodiment is described below using FIGS. 4 and 5. FIG. 4 is a side view of the optical head 10, and FIG. 5 is a central cross-sectional view taken across a Y-Z plane of the optical head.

After being emitted from a laser diode 18 installed in a casing 17, laser light 19 passes through a polarizing beam splitter 20 and then becomes a parallel pencil of beams on a collimating lens 21. Next after being reflected from a reflecting mirror 22, the pencil of beams passes through a polarizing diffraction grating 23 and is focused on an optical disk 5 by an objective lens 24. Reflected light from the optical disk 5 takes a route reverse to the above-mentioned route. That is to say, the reflected light is further reflected by the polarizing beam splitter 20 and reaches a photodetector 30. An output from the photodetector 30 is used to reproduce internal information of the optical disk 5. The output is also used to detect the position deviation signal indicating a deviation between a focal point of the laser light 19 and a recording surface of the optical disk 5, and a position deviation signal with respect to a recording track.

The output of the photodetector 30 is connected to a flexible cable 16 via an optical head circuit board 38. The optical head circuit board 38 has a laser driver IC 39 for controlling an output of the laser diode 18, and a cover 40 for releasing heat therefrom.

The polarizing diffraction grating 23 and the objective lens 24 are mounted in a lens holder 25, and four suspensions 26 are each fixed at one end (first end) to the lens holder 25 and at the other end (second end) to a holder 27 secured to the casing 17. The lens holder 25 also has a coil not shown, and the coil is combined with a yoke 28 and magnets 29, whereby a voice coil motor is formed. The above construction is typically called “two-dimensional actuator scheme”. In the actuator construction, supplying an electric current to the coil allows the lens holder 25 elastically supported by the suspensions 26, and the objective lens 24 and polarizing diffraction grating 23 integrated with the lens holder 25, to move in a two-dimensional space on the surface of the optical disk 5. In other words, the lens holder, the objective lens, and the polarizing diffraction grating can move in a vertical direction (Y-direction) and radial direction (X-direction) of the optical disk.

The focal point of the laser light 19 is positioned on the recording surface and recording track of the optical disk 5 by moving the lens holder 25 in the above-mentioned two-dimensional space in accordance with the above-mentioned two position deviation signals.

In this construction, the optical head 10 is dimensionally reduced by bending an optical path halfway. Accordingly, the laser diode (semiconductor laser diode) 18 is disposed at a position where its exit light faces in approximately the X-direction, not in the Z-direction, and a mirror 31 is added. Thus, the X-directional exit laser light 19 from the semiconductor laser diode 18 is bent toward the collimating lens 21, i.e., in the Z-direction. This construction makes it possible to narrow a clearance from the objective lens 24 to a guide bar 11b.

That the holder 27 is disposed on an optical path of the laser light 19, at a side opposite to the camera lens 2, with respect to the objective lens 24, is another factor contributory to downsizing. Such disposition of the holder 27, in turn, narrows the clearance from the objective lens 24 to the guide bar 11a.

However, if a holder 27 not having a notch 33 is disposed at the side opposite to the camera lens 2, with respect to the objective lens 24, the holder 27 will contact with the collimating lens 21. The holder 27 in that case will also intercept part of the laser light 19. In order to dispose the holder 27 at the side opposite to the camera lens 2 without increasing the thickness of the optical head 10, the holder 27 is provided with a relief clearance 32 for the collimating lens 21, and with a notch 33 for permitting the laser light 19 to pass through. The relief clearance 32 and the notch 33 respectively prevent the holder 27 from coming into contact with the collimating lens 21 and from intercepting the laser light 19. Since increasing the thickness of the optical head 10 leads to increasing the thickness of the optical disk video camera, the construction described above is also contributory to thickness reduction of the optical disk video camera.

The above embodiment applies when the camera lens 2 and the viewfinder 3 are arranged at upper positions of the video camera in a photographing condition. Even if the camera lens 2 or the viewfinder 3 is disposed at a lower position, however, a similar effect can be obtained by adopting inverse arrangement to that of the above embodiment, I.e., disposing the seek motor 12 at a position higher than that of the optical head 10, and the holder 27, at a position lower than the objective lens 24.

In the above embodiment, a seek motor 12 is used to actuate the optical head 10. However, any other appropriate actuator may be used instead. For example, an actuator adapted to have a gear-connected motor and lead screw section may be used or a linear voice coil motor may be used.

Although the seek motor 12 and the guide bar 11b are independently provided in the above embodiment, the seek motor 12 may have a lead screw 14 that also functions as the guide bar 11b. In other words, instead of the guide bar 11b, the lead screw 14 may be passed through the optical head 10 and caused to perform a function of the guide bar 11b. In this case, provided that a mirror 31 is disposed between the semiconductor laser diode 18 and the collimating lens 21, there is a possibility of the optical head 10 being disposable under the camera lens 2 or the viewfinder 3 without the height of the camera enclosure 1 being increased. The above possibility applies, even if the clearance from the objective lens 24 to the guide bar 11b located near the seek motor 12 is not narrowed In the above embodiment, the optical head 10 is disposed in the Z-direction next to the camera lens 2, on a projection plane parallel to the optical disk 5. The optical head 10, however, may be moved in the X-direction symmetrically with respect to a spindle motor 9 and disposed in the Z-direction next to the viewfinder 3. In this case, a thickness reduction effect similar to that of the above embodiment can be obtained by disposing the viewfinder 3 in such a form that on a surface perpendicular to the optical disk 5, part of the viewfinder overlaps on part of the optical head 10 and on the optical disk 5.

A combination of the embodiments described above is, of course, yet another embodiment of the present invention.

In the above embodiments, since the optical disk drive, the camera lens 2, and other elements are arranged considering the entire video camera, it is possible to reduce the video camera in dimensions, especially, in thickness.

Also, the above embodiments are valid for a construction in which an optical disk compliant with DVD standards, in particular, is used as a recording medium.

In addition, the above embodiments can be applied when the type of recording device used is not only an optical disk drive, but also a magnetic disk drive or the like.

What is claimed is:

1. An optical disk video camera, comprising:
a camera lens section that acquires image information of an object to be photographed; and
an optical disk drive that records on an optical disk the image information acquired by said camera lens section;
wherein:
said optical disk drive has an optical head; and
said camera lens section and said optical head are arranged such that respective positions projected onto a surface perpendicular to the surface of said optical disk and parallel to a central axis of said camera lens section will overlap at a portion on each other.

2. An optical disk video camera according to claim 1, wherein height of said optical disk is at most 10 mm larger than a diameter of said optical disk.

3. An optical disk video camera according to claim 2, wherein the diameter of said optical disk is 80 mm.

4. An optical disk video camera according to claim 1, wherein:
said optical disk drive has a guide bar that guides said optical head in a direction parallel to a central axis of said camera lens section; and
said camera lens section and said guide bar are arranged such that respective positions projected onto a surface parallel to the surface of said optical disk will not overlap on each other.

5. An optical disk video camera according to claim 1, wherein:
said camera lens section has a lens and a motor that moves said lens;
said optical disk drive has a guide bar that guides said optical head in a direction parallel to a central axis of said camera lens section; and
said motor and said guide bar are arranged such that respective positions projected onto a surface parallel to the surface of said optical disk will overlap on each other.

6. An optical disk video camera according to claim 1, wherein:
said optical disk drive comprises a drive that actuates said optical head in a direction of said optical disk; and
said drive, said optical head, and said camera lens are arranged so that when these three elements are projected onto a surface parallel to the surface of said optical disk, the projection of said drive will be disposed at a side opposite to the projection of said camera lens, with respect to the projection of said optical head.

7. An optical disk video camera according to claim 1, wherein said optical head comprises:
a laser diode that emits laser light;
an objective lens that focuses the laser light on said optical disk;
a lens holder that holds said objective lens;
a supporting member with a first end and a second end, said member using the first end to support said lens holder; and
a holder that holds the second end of said supporting member;
and wherein:
said laser diode, said holder, said objective lens, and said camera lens are arranged so that when these four elements are projected onto a surface parallel to the surface of said optical disk, the projection of said laser diode and the projection of said holder will be disposed at sides opposite to the projection of said camera lens, with respect to the projection of said objective lens.

8. A disk video camera, comprising:
a camera lens section that acquires image information of an object to be photographed; and
a disk drive that records on a disk the image information acquired by said camera lens section;
wherein:
said disk drive has a recording head; and
said camera lens section and said recording head are arranged such that when projected onto a surface perpendicular to the surface of said disk and parallel to a central axis of said camera lens section, said camera lens section and said recording head will overlap at a portion on each other.
